(19) United States
(12) Patent Application Publication
(10) Pub. No.: US 2011/0072022 A1
(43) Pub. Date: Mar. 24, 2011

(54) METHOD OF MANAGING LIFE STORIES

(76) Inventor: Patrick Tardif, Brentwood, CA (US)

(21) Appl. No.: 12/853,212

(22) Filed: Aug. 9, 2010

Related U.S. Application Data
(62) Division of application No. 11/618,438, filed on Dec. 29, 2006.

(51) Int. Cl. G06F 17/30

(52) U.S. Cl. 707/740; 707/E17.089

(57) ABSTRACT

System, method, and apparatus for users in an online computer system to write and keep in perpetuity their life Stories, Legacies, and Memorials and tie them together with relationships within social networks. A computer system collects data in the form of text or uploaded files entered by an individual who in turn can indicate other individuals to whom they have a relationship and include them in networks. The individual may cross reference chronological chapters with categories for referencing. The individual may select Guardians to control their data after they are deceased or otherwise incapacitated. A separate Foundation ensures storing the data in to ensure there is enough money to store the data in perpetuity.

### CROSS REFERENCE TO RELATED APPLICATION

This application is a divisional application, claiming the priority of co-pending U.S. application Ser. No. 11/618,438.

### STATEMENT REGARDING FEDERALLY SPONSORED RESEARCH

None

### REFERENCE TO SEQUENCE LISTING

None

### BACKGROUND OF THE INVENTION

The present invention relates generally to recording, displaying, and protecting information about entities in perpetuity, and will be specifically disclosed as a method and apparatus for recording, displaying, and protecting the life story of an individual or group in perpetuity.

Mindrum (U.S. Pat. No. 6,340,978) discloses a method relating to recording and displaying information about entities, including persons. Although Mindrum makes the assertion that the information relating to the entity may be kept in a “permanent” archive, no mention is made as to how the information will be maintained and/or how it will remain accessible.

The terms “permanent” and “forever” can be loosely used to suggest that data will be stored in perpetuity. However, the prior art fails to disclose any method or system that utilizes an algorithm that calculates costs of long term data storage, which often fluctuates, and keeps the data storage funds in an endowment to ensure that there are sufficient assets to continue storing the data safely in perpetuity. In addition, the prior art fails to disclose provisions to maintain the information, and access to that information should the distributor of that information be sold, go out of business, be acquired, etc. The chances of any company lasting “forever” or “permanently” are slim. The method disclosed herein minimizes the chance that data is lost or becomes inaccessible to future generations. Mindrum and other prior art fail to disclose the use of a separate entity (e.g. a Foundation) whose task it is to ensure that the entity or group's biographical information remain intact and accessible in perpetuity.

Mindrum is also limited in that the information pertaining to the entity must be associated with a calendar date. The prior art is based on chronological time frames where a user writes stories and assigns them titles and/or category types associated with dates. In contrast, the invention disclosed herein allows information pertaining to the individual or group to be entered and accessed entirely by category.

### BRIEF SUMMARY OF THE INVENTION

Accordingly, an object of the invention is to provide methods for providing access to biographical information about an entity in perpetuity.

Another object of the invention is to provide a method for presenting information about an entity in novel ways.

Additional objectives, advantages and novel features of the invention will be set forth in the description that follows and, in part, will become apparent to those skilled in the art upon examining or practicing the invention. The objects and advantages of the invention may be realized and obtained by means of the instrumentalities and combinations particularly pointed out in the appended claims.

Every year, thousands of biographies and autobiographies are published in book form. Dozens are published in the form of motion pictures or television dramas. Hundreds of thousands now appear in some form or other on personal home pages or web “blogs”.

Published and film biographies are typically limited to the rich, the famous, and the notorious. Some of these published stories are told over and over. For example, Amazon.com recently listed 339 books about Marilyn Monroe, 69 books about Al Capone, and 2,597 on or about John F. Kennedy. The stories of the vast majority of the billions of people now living, the billions already dead and the additional billions as yet unborn will be known only to those few people who know or knew them personally and will not long survive their subjects.

The invention disclosed herein is devoted to providing a digital “vault” for the perpetual storage of life histories and means by which those stories can be embodied in digital format and preserved in perpetuity. The biographical data may include written words, audio, and video recordings, as well as any other data that can be stored and accessed over digital media. The data will be stored by a separate foundation whose mission is to ensure the data is kept accessible and secure forever. It will be the repository of the life stories of every person on the planet who chooses to compose his or her biography or who can be reached by other persons interested in compiling that biography. This repository can reside on the world-wide web, accessible to all who wish to preserve their stories or read the stories of others.

The stories can be linked to form family trees, clan histories, the life experiences of people, ordinary and famous, rich and poor, living in the same province or city; or in numerous other ways that could illuminate the lived experience of the people of this world. Historians, ethnographers, sociologists, and other scholars would find a huge trove of material for recreating lost data and understanding the life of other cultures. Access restrictions necessary to protect the privacy of living participants would be implemented, and the Stories stored in perpetuity. The invention provides a method and apparatus for an author to record and provide access to information about themselves or another entity.

In one embodiment, screens are provided for an author to enter information that can be stored in a database according to settings established by the author. Authors may select several settings that control the accessibility of this data, and may purchase “perpetual storage” in the Foundation vault. The “Foundation” is a separate, but possibly related, business entity from the company that runs the day to day maintenance and management of the system that the Author or User interacts with.

A portion of the proceeds from the transaction is kept by the Foundation which is entrusted with using sufficiently updated technology to ensure security and long term data access and storage.

“Chapters” cover a period of time in a person's life. Chapters are typically events based and organized in chronological order. Chapters can also be titled and organized using distinct periods of time in the life of the individual such as “My Childhood”, “Grade School”, and “College”.

“Categories” cover areas of a person's life that may not fit into any particular time frame, or may cross multiple time frames, such as “My Inventions” or “My Career”. Categories allow the biographical information to be indexed and accessed on the basis of a common characteristic. Additionally, the system could automatically sequence the information based on their chronological order. The information could also be cross indexed for easy referencing and access.

An author may enter a Chapter, which is defined as a chronological time period set by a beginning and ending time frame. The author may create stories pertaining to this Chapter inside the Chapter and can write as many Stories per Chapter as desired. Further, the system may automatically sequence them based on their chronological ordering. Next, the author can set up Categories which are subject based, or topical. When the author is writing his or her Stories inside Chapters (in chronological order) he or she may then assign individual Stories to Categories. An example of a Chapter could be “My High School Years” or “My Early Childhood.” Examples of Categories could be things that span multiple chapters of someone's life like “My Pets” or “My Romances”.

Existing websites, whether pure social networking or biography writing sites, typically categorize stories by timelines, which can be a very useful method for ordering events logically. However, searching through someone's life story to find an item of particular interest can be unnecessarily time consuming. The invention herein solves the problem of having to manually search for a particular set of queries about a person by allowing an individual a way to cross reference events at any chronological time point. An individual may select any number of categories in which to cross reference items in the time line. Categories can span multiple chronological time frames. So rather than having the individual have to read through a person's entire chronological time frame or even skim all the titles, this invention provides a method to easily find all instances where such an item in a particular category is referenced, such as “My Pets” or “My Jobs”. Anyone reading an individual's Story (biographical information) can therefore easily read about items in the Story that are of particular interest. It also allows a user to find similar items more quickly as well as whether the author has similar interests to the individual reading the Story.

An example would be to think about Benjamin Franklin. For example, If Mr. Franklin writes 500 Stories in his Story site, ranging from growing up poor to his first day of school, to where his first pet died, to getting married, to his kid catching pneumonia. One can imagine a reader that does not wish to read the entire story, but instead wants to find out about his Inventions. Since Mr. Franklin created hundreds of inventions, this might ordinarily be difficult. However, using this system, all a reader would need to do is examine the Category “Inventions” to list all instances in his Life Story where he talks about inventions.

VERIFICATION: This procedure allows for a verification of the identity of the author or other provider of information and material into the system. This verification gives the public a degree of confidence in the information they are accessing, as well as discouraging the formation of phony accounts or misunderstandings concerning multiple people with similar names. A way to verify the information is to compare the person identified with the payment to the purported identity of the source of the information. The information can be sent through SSL (Secure Socket Layer) or similar utility to the merchant payment account and matched against the information in the source's Profile. When the information is deemed a match (i.e. “Verified” to be legitimate) then the source will receive the Verified status logo on your website. This will be viewable to anyone reading the biographical information. The source gets the Verified logo on their Story that shows the public that the source has been authenticated.

ENTITY CONFIGURATION: The invention disclosed herein ensures continued access to biographical information in a publicly accessible medium. When funds are received from the author or third party, those funds are placed into at least two separate, but possibly related, business entities. The first business entity receives funds from author, then places a portion of the funds into a first business entity and a portion into a second business entity. The first business entity conducts the routine management of the biographical information. The second business entity invests the funds it receives into account(s) such that the proceeds from those investments finance continued maintenance and storage of the biographical data in perpetuity. The business entities could be corporations (both for, and not for, profit), trusts, or any other legitimate business entity.

Although the specifics of how the system works may vary, Applicant believes that a preferred embodiment for running the system in perpetuity may take the following shape.

TERMS: R=Revenue generated in percentage per year. This revenue is estimated each year base on various indices, such as S&P 500 Index. C=Cost of maintaining 1 MB of data per year. This cost is calculated based factors such as electricity cost, wages, and hardware. D=Total amount of data in MB or TB. F=Total Fund amount. A=Adjustment cost per unit of data to cover losses or unexpectedly high returns on investment from previous years. The algorithm is as follows: F=((D×C)/R)+A.

GUARDIANS: The invention disclosed herein allows for continued human control to remain with the subject entity (e.g. author), or with that entity's designated “Guardian”. The Guardian system allows the subject entity (or author or user acting on behalf of the subject entity) to designate third parties to act on behalf of the entity to control the account of the author when the subject entity dies, becomes incapacitated, or loses interest in maintaining the information. That third party “guardian” can, in turn, designate one or more additional third parties to take control of the information using the same criteria discussed above.

The entity in control of the individual account (e.g. author or guardian) may elect to limit access of some or all of the biographical information (e.g. text, files, images, video, documents, and music). The access limitations can apply to people and time periods. For instance, the author could create a video file that is only to be viewed by the author's child when they reach a certain age.

Users may write memorials, tributes or other comments and request a link to the account created by the Author. The Author or other entity in control of the account may choose which, if any, to publish or link to the account.

### BRIEF DESCRIPTION OF THE DRAWINGS

FIG. 1 is a flow chart showing elements of an embodiment of the method of storing biographical data in perpetuity.

FIG. 2 is a flow chart showing elements of an embodiment of the method of providing for continued monitoring of biographical data using guardians.

FIG. 3 is a flow chart showing elements of an embodiment of the method of organizing and providing access to biographical information.

### DETAILED DESCRIPTION OF THE INVENTION

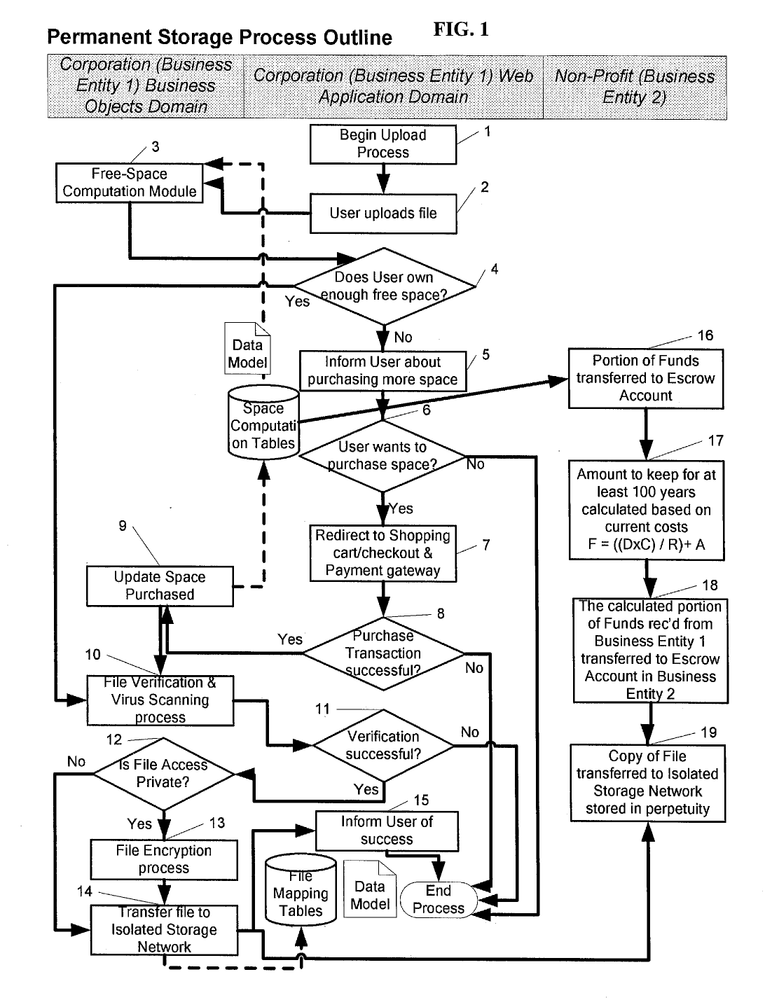

FIG. 1 is a flow chart showing elements of an embodiment of the method of storing biographical data in perpetuity.

Step 1. Allows the user to begin the upload process by ‘clicking’ or otherwise activating the process to upload the file to the web page. The file may include still pictures, video, audio, text, and/or other information.

Step 2. Shows the user selecting the file to upload. The user enters a title for the uploaded file and a description for the uploaded file. The user can mark the file as public or private or restricted to certain users. The user can specify a release date (date when the file will be available for viewing under prescribed circumstances).

Step 3. Here the user's database table is consulted to determine if the user has sufficient space to accommodate the file that is being uploaded.

Step 4. If sufficient space is available to accommodate the file being uploaded, the upload process is allowed to proceed.

Step 5. If insufficient space is available to accommodate the file being uploaded, the user is prompted to purchase more permanent space in the system.

Step 6. Here the user is directed to the e-commerce page where they can purchase additional space.

Step 7. The user goes to the e-commerce page where they can purchase additional space. After adding the purchase to the shopping cart and proceeding to checkout, the user is directed to the secure credit card payment gateway to complete the purchase. The “secure credit card payment gateway” can be any secure method of accessing payment over the internet.

Step 8. If the purchase transaction is concluded successfully and sufficient space is available to the user to upload the file, the process is allowed to continue. If not, the process ends.

Step 9. The details of the purchased space are updated to the user's table and a record of the purchases are updated to the database.

Step 10. Here, the uploaded file is verified to authenticate the file. It is also scanned for viruses and other malware.

Step 11. If the verification process of step 10 is successful, the process is allowed to continue. Otherwise, the process is terminated and the user is informed of the termination.

Step 12. Here, the access level of the user is determined. The following step(s) may be affected by whether the user has made the uploaded file public, private, or on a delayed release.

Step 13. If the user has marked the uploaded file as private, the file is passed to the encryption module that uses the user's credentials to encrypt the file. The encrypted file is not accessible by anyone other than the user.

Step 14. The uploaded file is then transferred to the secure isolated storage network for safekeeping. This storage network may include fault-tolerance, which is generally the ability of the system to respond gracefully to an unexpected hardware or software failure. There are many levels of fault tolerance, the lowest being the ability to continue operation in the event of a power failure. Operations are performed on two or more duplicate systems, so if one fails the other can take over.

Step 15. The user is informed of the success or failure of the preceding operation.

Step 16. A portion of the funds collected from the author/user are transferred to Business Entity 1 (e.g. corporation), and another portion of the funds collected are distributed to Business Entity 2 (e.g. non-profit corporation).

Step 17. The amount of funds collected and distributed is based on the algorithm for determining the cost of storing data (e.g. 1 megabyte) for at least 100 years. Applicant anticipates that technology will advance rapidly and dramatically in the next 100 years and beyond. Further, costs will be constantly changing, so a cost forecast for 100 years from a particular day (e.g. today) will be based on that day's costs (e.g. today's costs). The costs forecast will constantly move the starting point forward and project into the future 100 yrs from the new starting point. The algorithm [F=((D×C)/R)+A] is recalculated annually to ensure accuracy. F=Total Fund amount. D=Total amount of data in MB or TB. C=Cost of maintaining 1 MB of data per year. This cost is calculated based factors such as electricity cost, wages, and hardware. A=Adjustment cost per unit of data to cover losses or unexpectedly high returns on investment from previous years.

Step 18. Funds are collected, held and invested by a separate, but possibly related, business entity or “Foundation”. This second Business Entity's primary functions include providing the financial support to assure ongoing and perpetual access to the biographical data provided by the authors and users of this system. It is anticipated that Business Entity #2 may take the form of a non-profit corporation, however this is not necessarily a requirement. It is also anticipated that Business Entity #2 will assure future access to the biographical data regardless of the status of the Business Entity #1, which is the entity that runs the day to day management of the system. Therefore, authors and users of the system will be assured that even if Business Entity #1 becomes defunct, or otherwise ceases to continue future operations, the information they have provided will be available to them and others into the future.

Step 19. Includes a separate, managed copy of the data being stored in perpetuity with the Foundation. Continued access to the information is assured by funds from Business Entity #2, which is a separate business entity from the business entity that runs the day to day management of the system that the Author or User interacts with.

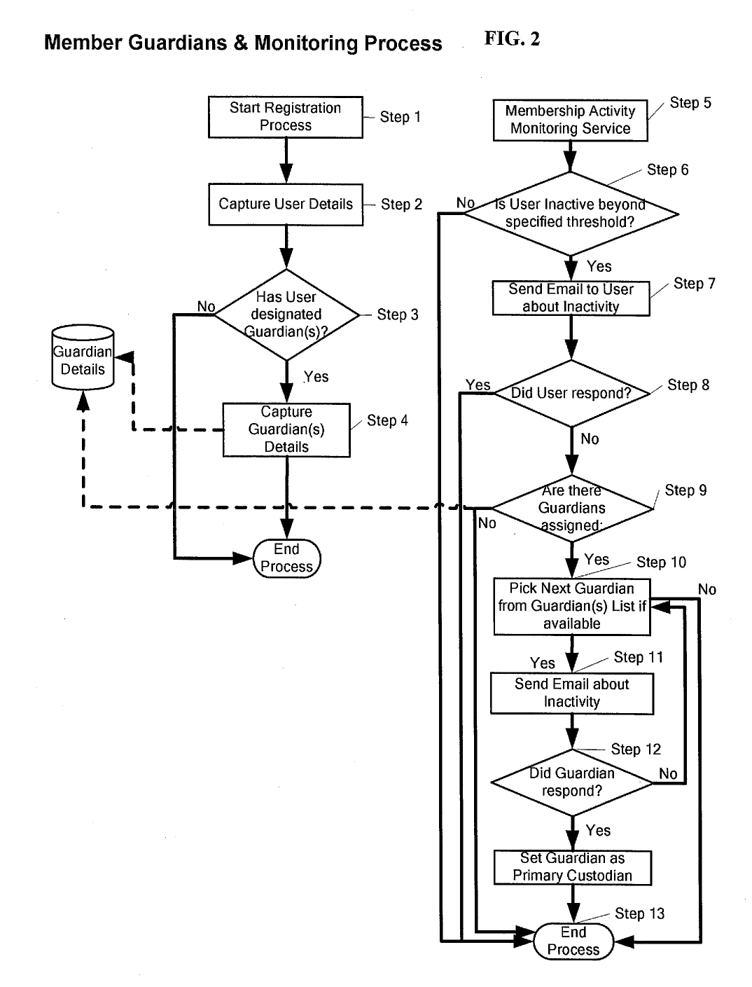

FIG. 2 is a flow chart showing elements of an embodiment of the method of providing for continued monitoring of biographical data using Guardians.

Step 1. Shows the User entering the registration process.

Step 2. The User provides information, such as contact information, preferences, and specific instructions.

Step 3. Determines whether the User has identified one or more Guardians, and their order of preference. For instance, the User may place John Smith as Guardian in first position, and Bob Jackson as Guardian in second position. As discussed above, under certain circumstances, a Guardian may be placed in control of the biographical content that the User has provided. These circumstances may include when the User dies, becomes incapacitated, and/or stops using or monitoring the site/content. The person in control of the biographical content is the Primary Custodian.

Step 4. Here the User can identify, and provide contact information for one or more Guardians that will, under specific circumstances, become the Primary Custodian. This information is saved.

Steps 5 and 6 illustrate where elements of the system, such as the Membership Activity Monitoring Service, monitor user activity/inactivity. If an account is inactive beyond the threshold specified in the business rules, the User is informed of the inactivity. The inactivity threshold may be set by Business Entity #1, which is responsible for the administration of the biographical content.

Step 7. Shows an email being sent to a User that has been inactive. This step may comprise an email, phone call, regular U.S. mail, or any other attempt to contact the User to assess their status.

Step 8. Determines whether the User responds to the inactivity report. If the User responds to the email, or other form of communication, and/or it is determined that the User shall continue to control the biographical information, the monitoring process is suspended for a period of time.

Step 9. If the User fails to respond, or it is otherwise determined that the User cannot or no longer wishes to control the biographical content as the Primary Custodian, and Guardians have been identified by the User, then the monitoring process continues.

Step 10. Here, the list of Guardians is extracted from the database and consulted. The Guardians are listed in order of preference selected by the User.

Step 11. Shows an email, or other form of communication, being sent to the Guardian. This communication may include information relating to the inactivity of the account, as well as the User's desire that the Guardian assume the position as the Primary Custodian.

Step 12. Determines whether the Guardian responded to the communication.

Step 13. If the Guardian responds appropriately, the Guardian is set as the Primary Custodian. If the Guardian does not respond appropriately, step 10 is revisited to identify the next Guardian on the list. If the next Primary Custodian cannot be determined using these steps, the biographical content may be frozen.

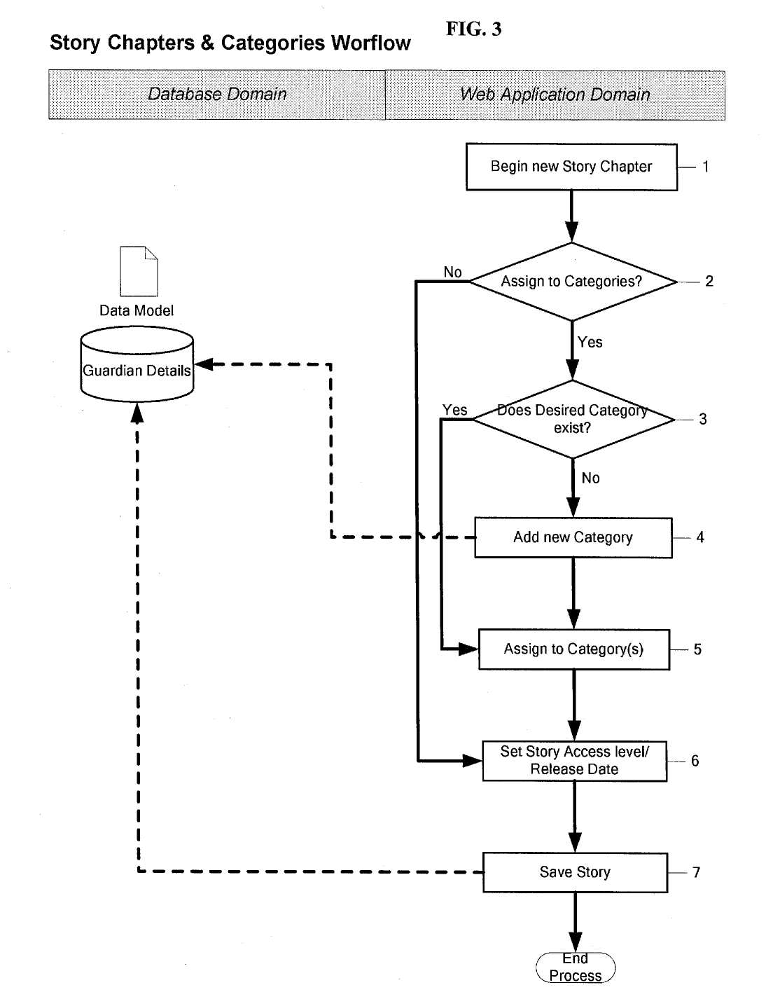

FIG. 3 is a flow chart showing elements of an embodiment of the method of organizing and providing access to biographical information.

Step 1. Allows the User to start a new Story Chapter. This may include providing biographical information relating to the User, and/or a third party.

Step 2. If the User wishes to assign the Story Chapter to a Category, the process continues.

Step 3. If the User wishes to assign the new Chapter to a previously non existing Category, then the User is prompted to add a new Category. For instance, if the User wishes to provide a Story Chapter to an existing Category, such as “My Pets”, then no new Category needs to be created. However, if the User wishes to create a Story Chapter that does not relate to an existing Category, such as “My Years In The Circus”, the User may create such a Category.

Step 4. Here, the User provides the information relating to the Category and the details are saved.

Step 5. Allows the User to assign the newly added Story Chapter to an existing or newly created Category. The information may be linked to one or more Categories.

Step 6. Allows the User to determine who may view the Story Chapter, and when. The user sets the Story's access level, for instance public, private, or restricted to certain users. Also, the User may provide a release date for the Story. If a release date is provided, the information will be made available for viewing on that date.

Step 7. Shows the newly created Story Chapter being saved to the database.

I claim:

1. A method of organizing and providing access to biographical information located on a computer system comprising:
a. Providing biographical information relating to a living entity;
b. Categorizing that information as a chapter;
c. Assigning the chapter to a category;
d. Providing information relating to the category;

2. The method of claim 1, wherein the access parameters to the biographical information is determined by the person that provided the biographical information.

3. The method of claim 1, wherein the chapter comprises biographical information relating to a distinct period of time.

4. The method of claim 1, wherein the category further comprises a means to allow for the organization and access of topics within the biographical information that are located across a plurality of chapters.

5. The method of claim 4, wherein the means to allow for the organization and access of topics comprise identifiers that relate the topics to specific categories.
